(19) United States
(12) Patent Application Publication
(10) Pub. No.: US 2020/0294153 A1
(43) Pub. Date: Sep. 17, 2020

(54) SYSTEMS AND METHODS FOR MONITORING PHARMACY INSURANCE CLAIM COSTS

(71) Applicant: Guardian Pharmacy, LLC, Atlanta, GA (US)

(72) Inventors: Mickey Dale Holbrook, Atlanta, GA (US); Ignacio Rossani-Ortega, Atlanta, GA (US)

(21) Appl. No.: 16/818,104

(22) Filed: Mar. 13, 2020

Related U.S. Application Data
(60) Provisional application No. 62/818,327, filed on Mar. 14, 2019.

(51) Int. Cl. G06Q 40/08; G06Q 10/10; G06Q 30/02; G06F 16/242

(52) U.S. Cl. CPC G06Q 40/08; G06F 16/2433; G06Q 30/0206; G06Q 10/10

(57) ABSTRACT

The disclosed technology includes systems and methods for monitoring pharmacy claim insurance cost. The disclosed system and methods can identify a prescription claim rejected by an insurance provider and subsequently monitor the rejected prescription claim for resubmission and acceptance by a payor of a modified prescription claim. When the payor accepts the modified prescription claim, the systems and methods can calculate the effective cost savings for the patient by calculating the out-of-pocket expenses for the prescription with no insurance applied, calculating the out-of-pocket expenses for the modified prescription with insurance applied, and determining the difference between the first and second calculations.

### CROSS REFERENCE TO RELATED APPLICATIONS AND PRIORITY CLAIM

This application is a non-provisional of, and claims priority under 35 U.S.C. § 119(e) to, U.S. Provisional Application No. 62/818,327, filed Mar. 14, 2019, of the same title, which is hereby incorporated by reference as if fully set forth below.

### FIELD OF DISCLOSURE

This present disclosure generally relates to monitoring prescription claims, and more particularly, to systems and methods for monitoring rejected prescription claims that are resubmitted and accepted and calculating cost savings.

### BACKGROUND

Conventional prescription billing processes can include a pharmacy first receiving a prescription from a patient, and the pharmacy then transmitting a prescription claim to the patient's insurance provider to confirm the amount the insurance company will pay toward the prescription and the amount of co-pay or co-insurance the patient will pay. But the insurance company can, and often does, reject the claim on multiple grounds. For example, the insurance company might allege that the prescription product is not covered under the patient's insurance policy or the prescription claim contains incorrect or missing information regarding the patient or prescription product. When the insurance company rejects the prescription claim, the patient typically pays the retail price for the prescription. The out-of-pocket cost when paying the retail price for the prescription can be significantly higher than the out-of-pocket cost of the prescription with insurance. In some instances, the pharmacy can choose to intervene on behalf of the patient. When the pharmacy chooses to intervene, the pharmacy can work with the patient and the patient's physician to attempt to change the prescription drug or product to a similar drug or product that is covered by the patient's insurance plan. When the pharmacy is able to change the prescription product to a drug or product that is covered by the patient's insurance (e.g., upon receiving authorization from the patient's physician), the pharmacy can resubmit the prescription claim to the insurance company in the hope that the insurance company will accept it. Similarly, if the pharmacy chooses to intervene, the pharmacy can correct any incorrect information from the original prescription claim and the new modified claim can be resubmitted and subsequently accepted by the insurance company. When the patient's insurance company accepts the resubmitted claim, the patient can pay an out-of-pocket cost that can be significantly lower than the out-of-pocket cost the patient would have had to pay if the pharmacy did not intervene.

When a pharmacy intervenes on behalf of a patient, resulting in an accepted prescription claim, the patient can enjoy significant cost savings. Therefore, a need exists for systems and methods that identify the frequency a given pharmacy chooses to intervene on behalf of a patient and attempts to modify the prescription claim for the patient's insurance provider to accept the prescription claim. Further, a need exists for systems and methods that can quantify the cost savings that can result where the pharmacy intervenes for a rejected claim and submits a modified prescription claim that subsequently is accepted by the patient's insurance provider.

### SUMMARY

These and other problems can be addressed by embodiments of the technology disclosed herein. The disclosed technology can include a method for calculating the cost savings a patient can obtain when a pharmacy system resubmits a prescription claim that was initially rejected by the patient's insurance provider and the resubmitted prescription claim is then accepted by the insurance provider. The method can include connecting to a pharmacy system that can store electronic claim submission data, extracting electronic claim submission data from the pharmacy system, storing the extracted electronic claim submission data in a database, detecting if the extracted electronic claim submission data includes a rejected claim, monitoring the rejected claim, detecting if the rejected claim is resubmitted by the pharmacy system and accepted by an insurance provider, and calculating an effective savings estimate. Further, the method can include calculating the effective savings by calculating the cost of a prescription without insurance applied, calculating the cost of the prescription with insurance applied, and determining the difference between the cost calculations.

The disclosed technology can include a system for monitoring insurance claim cost including a database that stores electronic claim submission data collected from a pharmacy system and a monitoring application. The monitoring application can detect if a claim for an original prescription is rejected by an insurance provider, monitor a rejected claim, detect if the rejected claim is resubmitted by the pharmacy system and accepted by the insurance company, and calculate an effective savings estimate.

Other implementations, features, and aspects of the disclosed technology are described in detail herein and are considered a part of the disclosed technology. Other implementations, features, and aspects can be understood with reference to the following detailed description, accompanying drawings, and claims.

### BRIEF DESCRIPTION OF THE FIGURES

Reference will now be made to the accompanying figures, which are not necessarily drawn to scale, and wherein:

FIG. 1 is an example communication flow according to the present disclosure;

FIG. 2 is an example network communication diagram according to the present disclosure;

FIG. 3 is a diagram of an example data collection process, according to the present disclosure;

FIG. 4 is a flow diagram illustrating detection and monitoring of a rejected prescription claim, according to the present disclosure;

FIG. 5 is a flow diagram illustrating calculation of effective savings, according to the present disclosure.

### DETAILED DESCRIPTION

Patients typically receive a prescription for a particular drug or product from their primary care physician or other specialized doctor. The patient can bring the prescription to a pharmacy to receive the prescribed drug or product. When the pharmacy receives the prescription, the pharmacy can electronically submit a prescription claim to the patient's insurance provider. The insurance provider can process the prescription claim and ultimately accept or reject the claim. When the insurance provider rejects the claim, the pharmacy can choose to intervene on behalf of the patient. The pharmacy can coordinate with the patient's physician to modify the prescription in a manner that would potentially allow the prescription claim to be accepted if the modified claim was resubmitted. If the insurance company accepts the modified prescription claim, the patient can enjoy the cost savings of obtaining a prescription that is at least partially paid for by the patient's insurance company. The disclosed technology includes systems and methods for monitoring and detecting whether a resubmitted prescription claim is accepted by the patient's insurance provider and subsequently calculating such effective savings.

The disclosed technology will be described more fully hereinafter with reference to the accompanying drawings. This disclosed technology can, however, be embodied in many different forms and should not be construed as limited to the examples set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

In the following description, numerous specific details are set forth. But it is to be understood that examples of the disclosed technology can be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

The term “patient,” “customer,” and their respective pluralized forms are used interchangeable throughout the description and should be construed to cover any individual who receives a prescription and/or any individual who takes a prescription to a pharmacy to obtain said prescription. The term “provider,” “physician,” “doctor,” and their respective pluralized forms are used interchangeably throughout the description and should be construed to cover any individual who can write a prescription for a drug or medical product. The term “payor,” “payor system,” “insurance company,” “insurance provider,” and their respective pluralized forms are used interchangeably throughout the description, and should be construed to cover any entity that can reimburse any portion of a cost to a customer, patient, provider, pharmacy, or other entity submitting a claim for reimbursement. The term “pharmacy,” “pharmacy system,” and their respective pluralized forms are used interchangeable throughout the description, and should be construed to cover any entity capable of receiving and dispensing prescriptions.

Example implementations of the disclosed technology will now be described with reference to the accompanying figures.

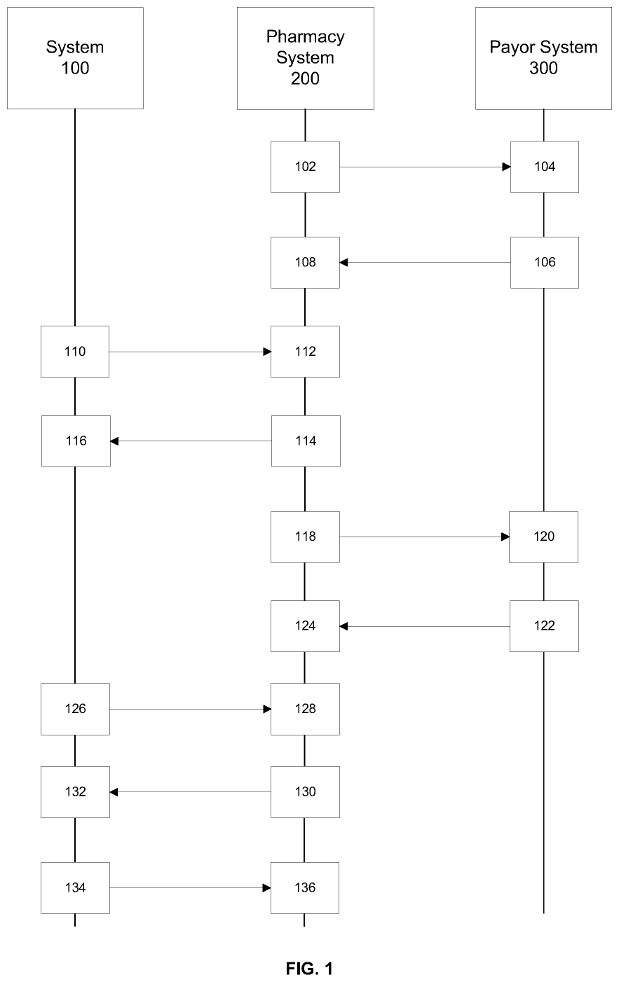

FIG. 1 is an example communication flow for electronic claim submission data in accordance with the present disclosure. As shown in FIG. 1, communications may flow between a system 100, a pharmacy system 200, and a payor system 300. When a patient receives a prescription for a drug or product from the patient's physician, the patient can bring the prescription to a pharmacy. The pharmacy can receive the prescription and electronically transmit 102 a prescription claim to a payor system via a network 10 between a pharmacy system 200 and a payor system 300. The prescription claim can include data such as the drug or product to be dispensed, the days' supply, whether the prescription claim relates to a new prescription or a refill prescription, billing-related information, and insurance-related information.

The payor system 300 can be associated with at least one payor. In one example, the payor system 300 can be an insurance provider, a financial institution, or any entity that can be financially responsible for the cost of the patient's prescription drug or product. The payor system 300 can receive 104 the prescription claim. The payor system 300 can determine whether to accept or reject the prescription claim by a variety of processes including but not limited to comparing the prescription claim to the patient's insurance policy and verifying the prescription claim contains accurate information. The payor system 300 can transmit 106 an acceptance or rejection of the claim back to the pharmacy system 200. The pharmacy system 200 can receive 108 the acceptance or rejection of the prescription claim and store the electronic claim submission data associated with the claim.

The system 100 can collect the stored electronic claim submission data from the pharmacy system 200 by connecting 110 to the pharmacy system 200 via a network 10. The pharmacy system can likewise connect 112 to the system 100 via the network 10. The pharmacy system 200 can transmit 114 the electronic claim submission data received from the payor system 300. The system 100 can receive 116 the electronic claim submission data the pharmacy system 200 received from the payor system 300.

The pharmacy can choose whether to intervene on behalf of the patient with the rejected prescription claim. When the pharmacy intervenes on behalf of the patient, the pharmacy, the patient, and the patient's physician can work together to attempt to modify the original prescription in a manner that would result in acceptance of the prescription claim by the payor. For example, if the prescription claim was rejected because the prescribed drug or product is not covered by the patient's insurance policy through the payor 300, the pharmacy and the physician can coordinate to modify the prescription to a similar drug or product that is covered by the patient's insurance policy. In one example, the physician can modify the prescription to a similar drug that has the same active ingredient, dosage, and/or route of administration as the original prescription drug.

The pharmacy system 200 can resubmit 118 the modified prescription claim to the payor system 300 via the network 10 between the pharmacy system 200 and the payor system 300. The payor system 300 can receive 120 the modified prescription claim and subsequently evaluate the modified prescription claim. The payor system 300 can use conventional processing techniques to evaluate the modified prescription claim. Subsequently, the payor system 300 can either accept or reject the modified prescription claim. By way of example, if the modified prescription claim includes a drug or product that is covered by the patient's insurance policy with the payor 300, the payor 300 will likely accept the modified prescription claim. The payor system 300 can transmit 122 the rejection or acceptance of the modified prescription claim to the pharmacy system 200. The pharmacy system 200 can receive 124 electronic claim submission data containing the acceptance or rejection of the modified prescription claim.

The system 100 can monitor the incoming electronic claim submission data from the payor system 200 after resubmission of the modified prescription claim. The system 100 can monitor subsequent electronic claim submission data by connecting 126 to the pharmacy system 200. The pharmacy system 200 can also connect 128 to the system 100 such that the system 100 and the pharmacy system 200 can be in constant communication. The pharmacy system 200 can transmit 130 electronic claim submission data received from the payor system 300 subsequent to the pharmacy system 200 submitting the modified prescription claim. The system 100 can receive 132 the subsequent electronic claim submission data from the pharmacy system 200. In one example, the system 100 can continuously connect to the pharmacy system 200 and receive the subsequent electronic claim submission data. In this configuration, the system 100 can continuously monitor the subsequent electronic claim submission data.

If the system 100 detects the modified prescription claim is accepted by the payor system 300, the system 100 can calculate an effective savings estimate for the patient. The system 100 can transmit 134 the calculated effective savings estimate to the pharmacy system 200.

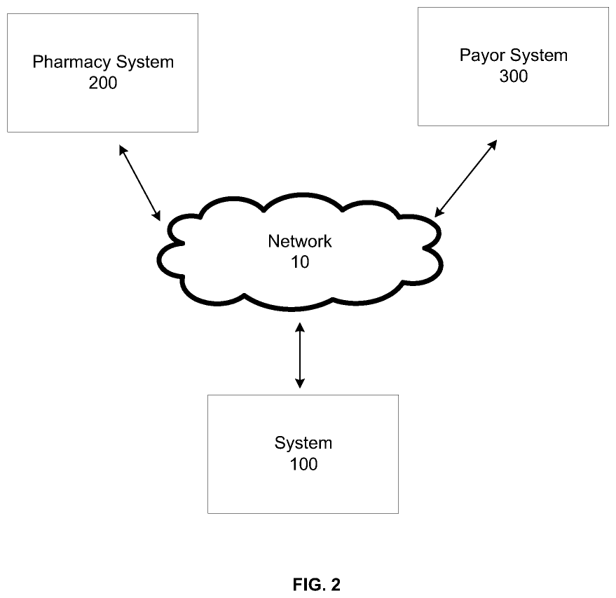

FIG. 2 illustrates network communication between the system 100, the pharmacy system 200, and the payor system 300. The system 100, the pharmacy system 200, and the payor system 300 can be in communication via at least one network 10. The network 10 may be of any suitable type, including individual connections via the internet such as cellular or WiFi networks. The network 10 may connect terminals using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns can dictate one or more of these types of connections be encrypted or otherwise secured. In one example, however, the information being transmitted can be less personal, and therefore the network connections can be selected for convenience over security.

The system 100, the pharmacy system 200, and the payor system 300 can each include a network interface. The network interface can be configured to allow the system 100, the pharmacy system 200, and the payor system 300 to communicate via the network 10. The network interface can be a network interface card, a modem, or the like. In one example, the network interface can be implemented in software.

In one example, a host server or clearinghouse can be an intermediary between the pharmacy system 200 and the payor system 300. In this configuration, the pharmacy system 200 can send the host server the prescription claim, and the host server can subsequently send the prescription claim to the payor system 300. Alternatively, the payor system 300 can send the return data including acceptance or rejection of the prescription claim to the host server, and the host server can then send the return data to the pharmacy system 200. The host server can perform any pre-processing or post-processing of the prescription claim, including validation of the information. In one example, the host server can serve as an intermediary for multiple payor systems 300. In this configuration, the host server can extract data from the prescription claim and subsequently send the prescription claim to the appropriate payor system 300.

The system 100 can be in communication via a network 10 with a plurality of pharmacy systems 200. For example, the system 100 can be configured to connect to a plurality of pharmacy systems 200 and extract electronic claim submission data from the pharmacy systems 200. Each pharmacy system 200 can be in communication with a plurality of payor systems 300. Patients who visit a given pharmacy can have a variety of insurance providers 300; therefore, the pharmacy system 200 can be configured to transmit and receive electronic claim submission data for a plurality of payor systems 300.

In one example, the system 100, the pharmacy system 200, and the payor system 300 can be in communication via the network 10 in real-time or near real-time. In this configuration, transmitting and receiving the electronic claim submission data can occur almost instantaneously as is practical based on the limitations of the network 10 and as will be understood by one of skill in the art. This can provide the pharmacy system 200 almost instantaneous notice of whether the prescription claim is accepted or rejected by the payor system 300. Similarly, the system 100 can almost instantaneously detect if a prescription claim has been rejected and/or resubmitted by the pharmacy system 200 and accepted by the payor system 300.

In one example, the system 100 can be a component of the pharmacy system 200. In this configuration, the system 100 can be a software application embedded in the pharmacy system 200. Alternatively, the system 100 can be separate and distinct from the pharmacy system 200. In this configuration, the system 100 can be at a location remote from the pharmacy system 200. The system 100 can be managed by a third-party unaffiliated with the pharmacy system 200.

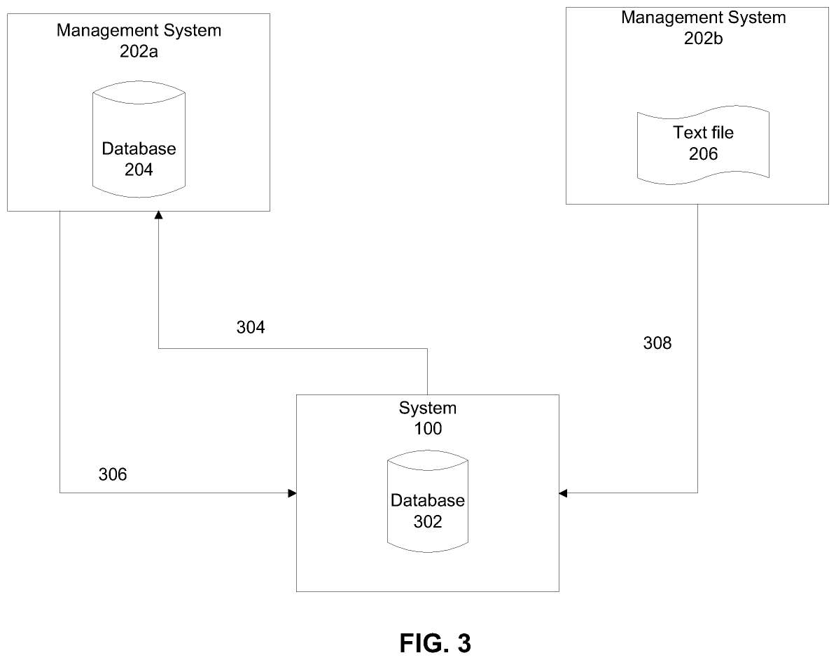

FIG. 3 illustrates a method of collecting electronic claim submission data from a pharmacy system 200. The pharmacy system 200 can include a management system 202 configured to operate a plurality of integral functions of the pharmacy system 200. In one example, the management system 202 can be configured to electronically transmit prescription claims to the payor system 300. The management system 202 can be configured to collect and store electronic claim submission data. Electronic claim submission data can include prescription claim data and payor acceptance and rejection data. The management system 202 can be configured to manage accurate dispensing of prescribed drugs and products to customers. The management system 202 can maintain a list of customer visits and the prescribed drugs and products dispensed to the customers. The management system 202 can track pharmaceutical batches and/or lots. The management system 202 can track the expiration date for products dispensed to customers.

The management system 202 can store electronic claim submission data received from the payor system 300 in a backend database 204 and/or a text-based file 206 of the pharmacy system. The method of collecting electronic claim submission data can depend upon whether the management system stores electronic claim submission data in a database backend 204 or a text-based file 206.

The backend database 204 can be controlled by memory controller devices (e.g., server(s), etc.) or software, such as document management systems, Microsoft™ SQL databases, SharePoint™ databases, Oracle™ databases, Sybase™ databases, or other relational databases. In one example, the backend database 204 can be an SQL database. The system 100 can connect 304 to the database backend 204 of the management system 202a. The system 100 can connect to the database backend 204 using a server-to-server connection. Once the system 100 is connected to the database backend 204, the system 100 can extract 306 the electronic claim submission data stored in the database backend 204. In one example, the system 100 can execute SQL scripts to extract the electronic claim submission data stored in the database backend 204. The system 100 can subsequently store the collected electronic claim submission data in one or more database(s) 302.

In an alternate example, the system 100 can extract 308 electronic claim submission data from the text-based file 206 of the management system 202b. The system 100 can extract 308 electronic claim submission data from the text-based file 206 without first directly connecting to the management system 200b (e.g. no server-to-server connection). Subsequently, the system 100 can store the collected electronic claim submission data in one or more database(s) 302. As with the backend database 204, the one or more database(s) 302 can store data and instructions used to perform one or more features of the disclosed technology and can be controlled by memory controller devices (e.g., server(s), etc.) or software, such as document management systems, Microsoft™ SQL databases, SharePoint™ databases, Oracle™ databases, Sybase™ databases, or other relational databases.

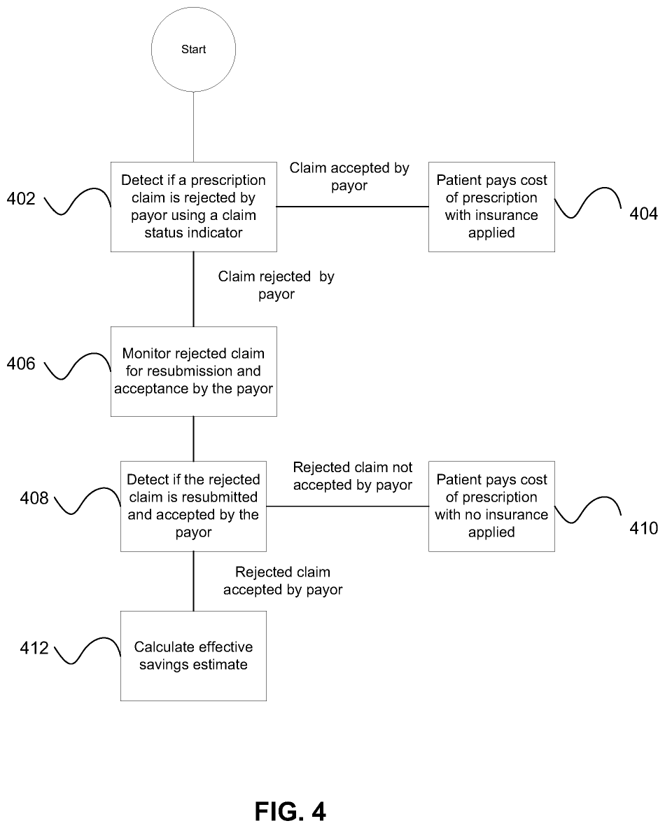

FIG. 4 is a flow diagram illustrating detection of a rejected prescription claim, according to some implementations. When the system 100 extracts electronic claim submission data from the pharmacy system 200 by a method as illustrated in FIG. 3, the system 100 can identify if the prescription claim is accepted or rejected by the payor system 300. The system 100 can detect 402 if a prescription claim is accepted or rejected using a claim status indicator. In one example, the claim status indicator can be a reject code provided in a reject code table. The reject code table can include a list of predefined reject codes and explanations established by the National Council for Prescription Drug Programs (“NCPDP”). For example, the reject code table can include a list of NCPDP reject codes in one column, and a list of corresponding explanations associated with each reject code in a second column. The reject code can be numeric, text, alphanumeric, or any combination of symbols used to indicate a rejected prescription claim. The reject explanation can provide why a particular claim was rejected. Example reject codes can include, but are not limited to, 01, 1C, 28, 95, AA, and 1001. Example corresponding causes can include but are not limited to, missing/invalid BIN number, missing/invalid smoker/non-smoker code, missing invalid date prescription written, time out, patient spenddown not met, and required segment writing. Alternatively, the system 100 can use one or more different reject code tables that are not associated with the NCPDP to detect whether a prescription claim is accepted or rejected by the payor system 300.

In one example, the system 100 can use a different reject code table depending on the pharmacy system 200. By way of example, the system 100 can detect if a prescription claim is rejected by a payor system 300 using the NCPDP reject code table for pharmacy system A and an alternative reject code table for pharmacy system B.

If the system 100 detects that the prescription claim is accepted by the payor system 300, the system 100 can take no further action. When the original prescription claim is accepted by the payor system 300, the patient can pay 404 the cost of the prescription with insurance applied. In one example, the patient can pay the co-pay or co-insurance amount associated with the patient's insurance coverage.

If the system 100 detects that the prescription claim is rejected by the payor system 300, the system 100 can monitor 406 incoming electronic claim submission data and detect 408 if the pharmacy system 200 resubmits a modified prescription claim that is subsequently accepted by the payor system 300. The pharmacy system 200 can continuously receive new electronic claim submission data from the payor system 300 associated with prescription claims the pharmacy system 200 transmitted to the payor system 300 that have been accepted or rejected. Therefore, the system 100 can continuously receive new electronic claim submission data from the pharmacy system 200 by continuously connecting and extracting electronic claim submission data as described herein and as illustrated in FIG. 3. The system 100 can monitor the subsequent electronic claim submission data and detect if the modified prescription claim is accepted by the payor 300 by comparing the prescription number and dispense date of the rejected original prescription claim to subsequent incoming electronic claim submission data from the payor system 300. The original prescription claim and the modified prescription claim can have the same prescription number and dispense date, allowing the system 100 to monitor and detect if the modified prescription claim has been accepted by the payor system 300 by searching incoming electronic claim submission data for an accepted claim with an identical prescription number and dispense date as the original prescription claim. In one example, the system 100 provide real-time or near real-time notifications that the payor system 300 accepted the resubmitted modified prescription claim. The notification can be displayed on a display interface. In one example, the notification is a color change of text, a pop-up box, or the like.

If the system 100 does not detect the modified prescription claim is accepted by the payor system 300, the system 100 can take no further action. In this situation, the patient can be required to pay 410 the cost of the modified prescription with no insurance applied. On the other hand, if the system 100 detects the modified prescription claim is accepted by the payor system 300, the system can calculate 412 an effective savings estimate.

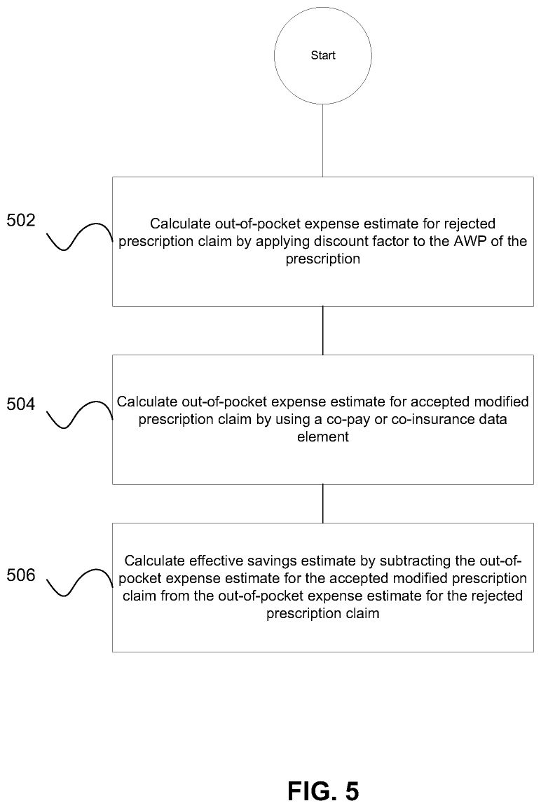

FIG. 5 is a flow diagram illustrating calculation of an effective savings estimate when the system 100 detects a modified prescription claim is accepted by a payor system 300. In one example, the system 100 can calculate the effective savings estimate in real time or near real time. The system 100 can calculate the out-of-pocket expense estimate the patient would have paid if the pharmacy did not choose to intervene. When the pharmacy does not intervene, there is no resubmission or acceptance of a modified prescription claim; therefore, the patient can be required to pay the price of the original prescription without insurance.

The system 100 can calculate 502 the out-of-pocket expense estimate by applying a discount factor to the Average Wholesale Price (AWP) of the original prescription. The AWP is the average price paid by a pharmacy to buy a drug from the manufacturer. The AWP can often be the manufacturer's suggested retail price of the prescription drug or product. The AWP can be used to determine pricing of a prescription at the pharmacy. The discount factor can be determined by the pharmacy and can be based on the pharmacy's pricing policy. For example, the pharmacy can vary the discount factor depending on the classification of the drug or product or based on the manufacturer or the drug or product. Further, the pharmacy can vary the discount factor based on the retail price of the drug or product or depending on current market trends and business realities of the pharmacy.

In one example, the discount factor is a static variable. When the discount factor is a static variable, the system 100 can apply the same discount factor for every calculation of effective savings. When the discount factor is a static variable, the system 100 can apply the same discount factor for each type of product and/or drug the pharmacy 200 dispenses, each brand of product and/or drug the pharmacy dispenses, and each insurance provider 300. Alternatively, the discount factor can be a dynamic variable. When the discount factor is a dynamic variable, different discount factors can be applied for each calculation of effective savings. For example, when the discount factor is a dynamic variable, the system 100 can receive instructions from user input or a separate system 100 component that can dictate the discount factor for a particular calculation of effective savings. In one example, the discount factor can vary depending on the type of product or drug, brand of product or drug, or insurance provider 300.

The system 100 can calculate 504 the out-of-pocket expense estimate by determining the co-pay or co-insurance amount the patient would pay when purchasing the modified prescription with insurance applied. Insurance information can be associated with each prescription claim contained in the electronic claim submission data. Therefore, the system 100 can extract insurance-related information from the accepted prescription claim using conventional processing techniques. The system 100 can subsequently identify the co-pay or co-insurance data element in the accepted modified prescription claim. The co-pay data element can represent a fixed amount that a patient can pay for a prescription that can be predetermined by the payor 300. The co-insurance data element can represent a percentage of the cost for a prescription that a patient can pay for the prescription after the patient has reached the deductible of their insurance plan with the payor. As will be appreciated, the co-pay and co-insurance amounts can be significantly less than the price of the prescription without insurance.

The system 100 can calculate 506 the effective savings estimate by subtracting the co-pay or co-insurance expense estimate from the out-of-pocket expense estimate. The effective savings estimate can indicate the dollar amount the patient saved due to the resubmission and subsequent acceptance of a modified prescription claim.

In one example, the system 100 can calculate the effective savings estimate for an aggregate of resubmitted modified prescription claims. Each prescription claim can correlate to at least one prescription and at least one payor system 300. The effective savings estimate for an aggregate of modified prescription claims can indicate the dollar amount a plurality of patients saved due to the resubmission and subsequent acceptance of a modified prescription claim. In one example, the effective savings estimate for an aggregate of resubmitted modified prescription claims can indicate the total savings a pharmacy provided to its patients over a particular time period. For example, the effective savings estimate can indicate the pharmacy provided a determined amount of effective savings to patients over the course of one year.

Alternatively, the effective savings estimate for an aggregate of modified prescription claims can indicate an average of effective savings each patient received due to the pharmacy intervening. Further, the effective savings estimate for an aggregate of resubmitted modified prescription claims can indicate the frequency at which the pharmacy chose to intervene on behalf of a patient by coordinating with a patient's physician to modify the prescription and subsequently resubmit the modified prescription claim to the payor system 300. In one example, the effective savings estimate for an aggregate of prescription claims can indicate the dollar amount of savings typical of an original prescription claim rejected for a particular reason or how often the pharmacy chooses to intervene for each rejection reason. By way of example, the effective savings estimate can indicate that when a prescription claim is denied because the drug is not covered under the patient's insurance policy, the pharmacy intervenes a certain percentage of the time. Alternatively or in addition to, the effective savings can indicate that when a prescription claim is denied because the drug is not covered under the patient's insurance policy, the modified prescription claim is accepted a certain percentage of the time and generates an certain approximate of effective savings of a particular dollar amount for each patient.

In one example, the system 100 can transmit the effective savings estimate in a readable format to the pharmacy system 200. For example, the effective savings can be transmitted to display in a table, chart, graph, or other suitable format that allows a patient to easily see the effective savings estimate. In one example, the pharmacy can use the readable format display of the effective savings estimate for marketing and advertising. The pharmacy can attract new customers by displaying the potential savings a customer can obtain if the patient uses the pharmacy for filling prescriptions. In one example, the effective savings can be illustrated in a format to indicate how often a pharmacy intervenes by coordinating with a patient's physician and insurance provider to modify the prescription for future resubmission and acceptance of the prescription claim.

The system 100 can include a memory. The memory can include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. The processing techniques described herein, including detecting rejected prescription claims, monitoring electronic claim submission data for resubmission and acceptance of a rejected prescription claim, and calculating effective savings estimate, can be implemented as a combination of executable instructions and data within the memory. In one example, the memory can include instructions, that when executed by a processor, perform one or more processes consistent with the functionalities disclosed herein. Methods, systems, and articles of manufacture consistent with disclosed embodiments are not limited to separate programs or computers configured to perform dedicated tasks.

The system 100 can include a processor. The processor can include one or more of a microprocessor, microcontroller, digital signal processor, co-processor or the like or combinations thereof capable of executing stored instructions and operating upon stored data. The processor can be one or more known processing devices, such as a microprocessor from the Pentium™ family manufactured by Intel™ or the Turion™ family manufactured by AMD™. The processor can constitute a single core or multiple core processor that executes parallel processes simultaneously. For example, the processor can be a single core processor that is configured with virtual processing technologies. In certain examples, the processor can use logical processors to simultaneously execute and control multiple processes. The processor can implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

What is claimed is:

1. A method for monitoring insurance claim cost, the method comprising:
connecting to a pharmacy system, the pharmacy system configured to store electronic claim submission data;
extracting electronic claim submission data from the pharmacy system;
storing extracted electronic claim submission data in a first database;
detecting if extracted electronic claim submission data includes a rejected claim, where a rejected claim is a claim rejected by a payor;
monitoring the rejected claim; and
responsive to detecting that the rejected claim is resubmitted by the pharmacy system and accepted by the payor, calculating an effective savings estimate.

2. The method of claim 1, wherein the pharmacy system includes a second database configured to store electronic claim submission data.

3. The method of claim 2, wherein the second database is a structure query language database.

4. The method of claim 2, wherein the first database connects to the second database using a server-to-server connection.

5. The method of claim 2 further comprising:
extracting electronic claim submission data from the pharmacy system by applying structure query language scripts; and
storing extracted electronic claim submission data in the first database.

6. The method of claim 1, wherein the pharmacy system includes a text-based file configured to store electronic claim submission data.

7. The method of claim 6 further comprising:
extracting electronic claim submission data from the text-based file; and
storing extracted electronic claim submission data in the first database.

8. The method of claim 1, wherein detecting the rejected claim further comprises identifying a reject code associated with the rejected claim.

9. The method of claim 8, wherein the reject code corresponds to a reject cause.

10. The method of claim 1, wherein monitoring the rejected claim further comprises comparing a prescription number and a dispense date of the rejected claim to electronic claim submission data including a plurality of prescription claims each having a prescription number and a dispense date.

11. The method of claim 1, wherein calculating the effective savings further comprises:
calculating a cost of the rejected claim without insurance applied;
calculating a cost of an accepted claim with insurance applied; and
determining a difference between the cost of the rejected claim without insurance applied and the cost of the accepted claim with insurance applied.

12. The method of claim 11, wherein the rejected claim corresponds to an original prescription and the accepted claim corresponds to a modified prescription.

13. The method of claim 11, wherein the cost of the rejected claim without insurance applied is calculated by applying a discount factor to an average wholesale price of the original prescription.

14. The method of claim 13, wherein the discount factor is a static variable consistently applied to each effective savings estimate calculation.

15. The method of claim 11, wherein the cost of the accepted claim with insurance applied is calculated by:
extracting insurance information of the accepted claim from electronic claim submission data; and
identifying a co-insurance and/or co-pay data element associated with the accepted claim.

16. The method of claim 1 further comprising transmitting the effective savings estimate to the pharmacy system.

17. The method of claim 16, wherein the transmitted effective savings estimate is displayed in a readable format.

18. The method of claim 1 further comprising calculating the effective savings estimate for an aggregate of resubmitted and accepted claims, wherein each claim correlates to at least one prescription and at least one payor.
